(19) United States
(12) Patent Application Publication
(10) Pub. No.: US 2013/0205402 A1
(43) Pub. Date: Aug. 8, 2013

(54) Apparatuses and methods for content protection using Digital Rights Management (DRM) in WebView or WebKit

(71) Applicant: ConDel International Technologies Inc., George Town (KY)

(72) Inventors: Yeu-Chung LIN, Chang-hua (TW); Kwok-Chen TSENG, Longtan Township (TW)

(73) Assignee: ConDel International Technologies Inc., George Town (KY)

(21) Appl. No.: 13/835,061

(22) Filed: Mar. 15, 2013

(51) Int. Cl. G06F 21/10

(52) U.S. Cl. CPC G06F 21/10
USPC 726/26

(57) ABSTRACT

An electronic device is provided with a DRM agent, a plug-in, and a web browser. The DRM agent processes DRM-protected content associated with an electronic file or a web page. The plug-in enables access of the electronic file. The web browser comprises a WebView SDK installed with the DRM agent or a WebKit engine installed with the DRM agent. The WebView SDK activates the processing of the DRM-protected content of the DRM agent to obtain the web page portion-by-portion, and displays the web page with the obtained portions. The WebKit engine activates the processing of the DRM-protected content of the DRM agent to obtain the electronic file or web page portion-by-portion, and uses the plug-in or a native media player to access the electronic file with the obtained portions, or displays the web page with the obtained portions.

### BACKGROUND OF THE INVENTION

1. Field of the Invention

The invention generally relates to the field of digital content protection, and more particularly, to apparatuses and methods for digital contents protection using Digital Rights Management (DRM) by installing a DRM agent in the WebView Software Development Kit (SDK) and/or the WebKit engine of a web browser.

2. Description of the Related Art

Digital Rights Management (DRM) is an access control technology that is wildly used by hardware manufacturers, publishers, copyright holders, or individuals with the intent to limit the use of digital content. The original digital content to be protected is packaged and encrypted by a DRM server, and the DRM-protected content may be provided locally or accessible remotely via the Internet to users. For the case where the DRM-protected content is provided locally, an associated software application, such as Windows Media Player, QuickTime, or others, installed with a DRM agent is invoked for loading or executing the DRM-protected content. Specifically, the DRM agent first decrypts and un-packages the DRM-protected content to obtain the original digital contents, and then provides the original digital content to be accessed by the associated software application according to one or more Rights Objects (ROs) which specify the permissions for the uses of the original digital content. For the case where the DRM-protected content is accessible remotely, a web browser is launched to obtain the DRM-protected content according to a certain communication protocol, such as the Hyper Text Transfer Protocol (HTTP). Next, similar to the first case described above, an associated software application installed with a DRM agent is responsible for loading or executing the DRM-protected content.

Note that, the conventional implementation of digital content protection using DRM is to install the DRM agent in the software applications. For example, the DRM agent may be installed in a VLC media player for playing the DRM protected multimedia files, or installed in a Sumatra Portable Document Format (PDF) viewer for viewing the DRM protected electronic files with the file extension of “pdf”. If several data formats are used for the original digital content, it is required to install a respective DRM agent in each of the associated software applications. However, the conventional implementation has a huge drawback as it requires the source code of the software applications for the DRM agent to be installed therein, or worse, it requires the source code of the Operating System (OS) and the configurations of the hardware resources for the DRM agent to be installed in the kernel of the OS. It is very likely that the company developing the software applications or OS will not be willing to authorize the source code to a third party. Also, the cost for authorization may be high, and the complexity for installing the DRM agent may be large.

### BRIEF SUMMARY OF THE INVENTION

With advances in networking technologies, the diversity of and the way of access to digital content have increased rapidly. For example, the HyperText Markup Language (HTML) supports displaying of texts, images, and java scripts, while the new HTML5 additionally supports playing of video and audio files with a native player of a web browser, and supports playing of 3D gaming or Augmented Reality (AR) multimedia files with a plug-in (e.g., Unity 3D Game Engine) for the web browsers. Since more and more multimedia/data files are being accessible by the web browsers, the invention proposes an efficient choice for users to use a single web browser as the means for accessing different types of digital content, instead of using a plurality of software applications which are required to be pre-installed with DRM agents individually. Therefore, the invention aims to solve the aforementioned problems concerning the installation of DRM agents to the plurality of software applications, and proposes apparatuses and methods for digital content protection using DRM in the WebView Software Development Kit (SDK) and/or the WebKit engine of a web browser, such as the Firefox, Chrome, Opera, or Safari web browser, etc., for the Mac OS X or iOS system. In addition, the apparatuses and methods for digital content protection using DRM may also be applied in the WebKit engine of a web browser for the operating systems other than the Mac OS X and iOS system, e.g., the Windows XP/7/8 system or Android, which provide the WebView SDK with different architecture or do not provide the WebView SDK at all.

In one aspect of the invention, an electronic device for protecting digital content, including web pages and electronic files, e.g., program files and multimedia/data files, using DRM is provided. The electronic device comprises a DRM agent, a plug-in, and a web browser. The DRM agent is configured to process DRM-protected content associated with an electronic file or a web page. The plug-in is configured to enable access of the electronic file. The web browser comprises a WebView SDK installed with the DRM agent and/or a WebKit engine installed with the DRM agent. The WebView SDK or WebKit activates the processing of the DRM-protected content of the DRM agent to obtain the electronic file or the web page portion-by-portion, and displays the electronic file or the web page with the obtained portions by the web browser, the plug-in, or a native player of the web browser.

In another aspect of the invention, a method for digital content protection using DRM in an electronic device is provided. The method comprises the steps of launching a web browser comprising a WebView SDK installed with a DRM agent and/or a WebKit engine installed with the DRM agent, wherein the DRM agent is configured for processing DRM-protected content associated with an electronic file, such as a program file or a multimedia/data file, or a web page; activating, by the WebView SDK and/or WebKit Engine, the DRM agent to process the DRM-protected content for obtaining the electronic file or the web page portion-by-portion, and displaying, by the WebView SDK or the WebKit Engine, the web page with the obtained portions, or the electronic file with the obtained portions using a plug-in or a native player of the web browser.

In yet another aspect of the invention, an electronic device for protecting digital content, including web pages and electronic files, using DRM is provided. The electronic device comprises a plurality of DRM agents, a plug-in, and a web browser. The DRM agents support a plurality of DRM schemes for processing DRM-protected content associated with an electronic file, such as a program file or a multimedia/data file, or a web page using one of the DRM schemes. The web browser comprises a WebView SDK installed with the DRM agents and/or a WebKit engine installed with the DRM agents. The WebView SDK or the WebKit engine activates the processing of the DRM-protected content of the DRM agents in order to determine whether the content is DRM protected and which DRM scheme is used to protect the content, and to use the corresponding DRM agent of the determined DRM scheme to obtain the electronic file or the web page portion-by-portion, and displays the electronic file or the web page with the obtained portions by the web browser, the plug-in, or a native player of the web browser.

Other aspects and features of the invention will become apparent to those with ordinary skill in the art upon review of the following descriptions of specific embodiments of the electronic devices and methods for digital content protection using DRM.

### BRIEF DESCRIPTION OF DRAWINGS

The invention can be more fully understood by reading the subsequent detailed description and examples with references made to the accompanying drawings, wherein:

FIG. 1 is a block diagram illustrating the software architecture of an electronic device according to an embodiment of the invention;

FIG. 2 is a block diagram illustrating the hardware architecture of an electronic device according to an embodiment of the invention;

FIG. 3 is a flow chart illustrating the operations of the canInitWithRequest method, the startLoading method, and the stopLoading method installed with the DRM agent module 20 according to an embodiment of the invention;

FIGS. 4A and 4B show a flow chart illustrating the determination of whether the resource is DRM protected according to an embodiment of the invention;

FIG. 5 is a flow chart illustrating the operation of the customized MediaPlayerPrivateQTKit class according to an embodiment of the invention;

FIG. 6A is a schematic diagram illustrating the calling sequence of the classes in the WebKit engine involved during the loading of the DRM-protected content associated with an electronic file according to an embodiment of the invention; and

FIG. 6B is a schematic diagram illustrating the returning sequence of the classes in the WebKit engine involved during the loading of the DRM-protected content associated with an electronic file according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

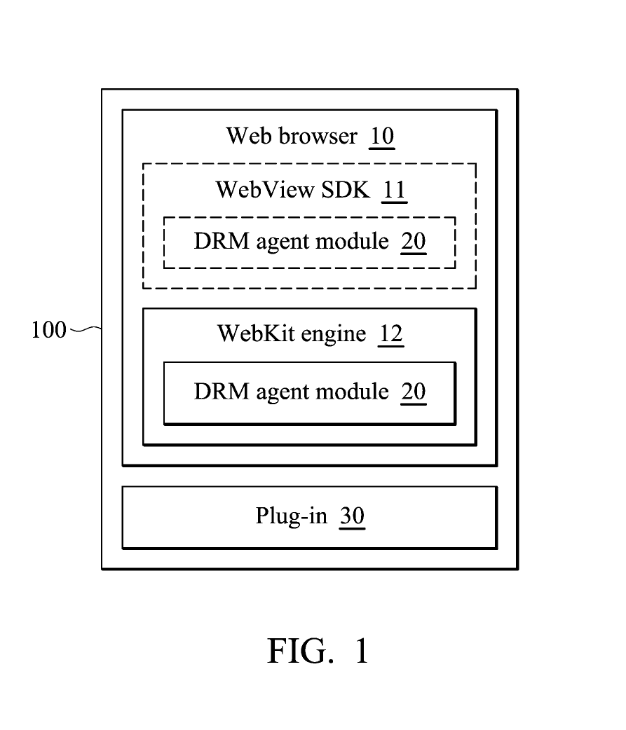

FIG. 1 is a block diagram illustrating the software architecture of an electronic device according to an embodiment of the invention. The software architecture 100 of the electronic device contains a web browser 10, a DRM agent module 20, and a plug-in 30. The web browser 10 includes a WebKit engine 12 installed with the DRM agent module 20 (denoted with solid lines), and optionally a WebView Software Development Kit (SDK) 11 installed with the DRM agent module 20 (denoted with dotted lines), due to the fact that a web browser may be constructed by only a WebKit engine or both of a WebView SDK and a WebKit engine. The web browser 10 is a software application which provides the functionality of a web browser for retrieving, presenting, and traversing information resources either in a local storage device or in a remote storage device which is accessible to the electronic device following certain specific communication protocols. Specifically, an information resource may be identified by a Uniform Resource Identifier (URI) and may be a web page, an electronic file (e.g., a multimedia/data file or a program file), or other piece of content. Alternatively, the web browser 10 may also be used to access information provided by locally maintained electronic files. The web browser 10 may be a Firefox, Chrome, Chromium, Opera, or Safari web browser for the Mac OS X or iOS system (or other systems operating in similar architecture of the Mac OS X or iOS system), or a web browser constructed by WebView SDK and/or WebKit engine bearing similar functions of the aforementioned ones, etc.

The WebView SDK 11 is generally referred to as a view class that displays web pages, and this view class is the basis upon which provides a set of Application Programming Interfaces (APIs) for users to roll the web browser 10 or simply display some online or local contents. The WebView SDK 11 may use the underlying WebKit engine 12 to display web pages, and also include methods to navigate forward and backward through a history, zoom in and out, perform text searches, and more. Note that, the WebKit engine 12 is an open source browser engine, while the WebView SDK 11 may also be open sourced as well or provides only a set of APIs, depending on the web browser and the operating system in use. For example, in the web browser for the Mac OS X or iOS system, the WebKit engine 12 is open sourced, while the WebView SDK 11 is not open sourced and only provides a set of APIs. In the Chromium web browser for any operating system, both of the WebView SDK 11 and the WebKit engine 12 are open sourced.

The plug-in 30 may also be referred to as a web browser extension or an add-on, which generally refers to a computer program for extending the functionality of a web browser, e.g., the web browser 10. In this embodiment, the plug-in 30 enables the access of certain electronic files, including program files and multimedia/data files, for the web browser 10. For example, the plug-in 30 may be a Flash plug-in for providing the functionality similar to the Adobe Flash Player, and the electronic files executable to the Flash plug-in have file extensions of “swf”. The plug-in 30 may be a SilverLight plug-in for providing the functionality similar to the SilverLight Player, and the electronic files executable to the SilverLight plug-in have file extensions of “xap”. The plug-in 30 may be a Unity 3D plug-in for providing the functionality similar to the Unity 3D Game Engine, and the electronic files executable to the Unity 3D plug-in have file extensions of “unity3d” or “js”. The plug-in 30 may be a Window Media Player (WMP) plug-in for providing the functionality similar to the WMP, and the electronic files executable to the WMP plug-in have file extensions of “wmv” or “wma”. The plug-in 30 may be a QuickTime plug-in for providing the functionality similar to the QuickTime player, and the electronic files executable to the QuickTime plug-in have file extensions of “mov” or “qt”. The plug-in 30 may be an Adobe Reader plug-in for providing the functionality similar to the Adobe Reader, and the electronic files corresponding to the Adobe Reader plug-in are the data files with the file extension of “pdf”. It is to be understood that, although the plug-in 30 is shown as singular, the software architecture 100 of the electronic device may contain multiple plug-ins for access of different types of electronic files, and the invention is not limited thereto.

Specifically, because the plug-in 30 is installed in the web browser 10, the web browser 10 may detect the existence of the plug-in 30, and when the web browser 10 is required to access the electronic files executable to the plug-in 30, it may invoke the plug-in 30, i.e., using the plug-in 30, to access the electronic files. Note that, during the access of the electronic files, any input and output associated with the electronic files are made through the web browser 10. Taking a Flash file being accessed as an example, if the Flash file requires a user to input a command, the command will be received by the web browser 10 via an I/O device (not shown), such as a keyboard, a touch pad, or a touch panel, etc., and then forwarded to the plug-in 30. Likewise, if the Flash file requires the invoking of other Flash files or multimedia/data files, the requirement will be directed to be handled by the web browser 10.

The DRM agent module 20 is a trusted entity in compliance with the DRM protocol(s) of one or more DRM schemes, i.e., the DRM agent 20 may support the use of a plurality of DRM schemes, wherein each DRM scheme is practically performed by a specific corresponding DRM agent. The DRM agent module 20 is responsible for processing DRM-protected content according to one or more Rights Objects (ROs) corresponding to the DRM-protected content, which define permissions for accessing the DRM-protected content in the electronic device, using the supported the DRM schemes. The processing includes decrypting and un-packaging of the DRM-protected content, and enforcing permissions and constraints associated with the DRM-protected content, as well as controlling access to the DRM-protected content. Note that, the DRM agent module 20 is installed in the web browser 10, and the access to any DRM-protected content must be made through the web browser 10. And because of this, system performance and processing efficiency may be improved, since the DRM-protected content may be displayed or accessed directly in the web browser 10 without redirecting the DRM-protected content to be handled by external software applications, which is the routine for the conventional ways of implement DRM agent on application software, rather than on web browser. As well, due to the DRM agent module 20 incorporates a plurality of DRM agents, this embodiment can solve the interoperability problem among different DRM schemes.

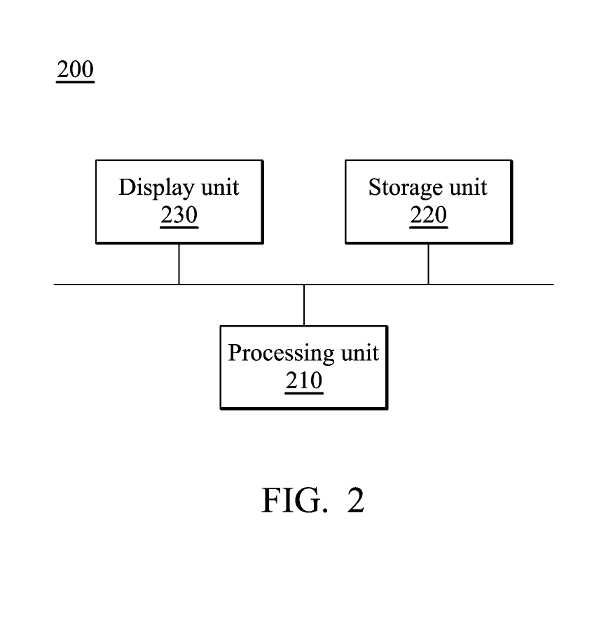

FIG. 2 is a block diagram illustrating the hardware architecture of an electronic device according to an embodiment of the invention. The hardware architecture 200 of the electronic device contains a processing unit 210, a storage unit 220, and a display unit 230. The processing unit 210 may be a general-purpose processor, an application processor, or a Micro-Control Unit (MCU) of the electronic device. The storage unit 220 may be a volatile memory, such as a Random Access Memory (RAM), a non-volatile memory, such as a flash memory, a hard disk, an optical disk, or any combination thereof, for storing the DRM-protected content and the program code or machine code of the web browser 10, the DRM agent module 20, and the plug-in 30, which when loaded and executed by the processing unit 210, may perform the respective functions thereof. In addition, the storage unit 220 may also store the RO(s) corresponding to the DRM-protected content, wherein the DRM-protected content and the RO may be received from a DRM server (not shown) remotely located on the Internet, or may be read out from another storage medium (not shown) accessible when coupled to the electronic device. The display unit 230 may be a Cathode Ray Tube (CRT) screen, a Liquid Crystal Display (LCD), a plasma display panel, or others, for displaying a graphic user interface of the web browser 10, which the user may interact with. Although not shown, the hardware architecture 200 may comprise other functional units, such as a keyboard/keypad, a mouse, a touch pad, or a communication unit, such as an Ethernet card/chipset, a Wireless-Fidelity (WiFi) card/chipset, or a Baseband and Radio Frequency (RF) chipset for cellular communications.

Please note that, the web browsers for the Mac OS X or iOS system, in which the WebView SDK and/or WebKit engine is/are installed with the DRM agent module 20, are different from the genuine web browsers for the Mac OS X or iOS system released to the public, and they may be referred to as custom web browsers made and used specifically in this invention.

In response to the web browser 10 comprising the WebView SDK 11 installed with the DRM agent module 20, the WebView SDK 11 activates the processing of the DRM-protected content of the DRM agent module 20 to obtain the web page portion-by-portion, and displays the web page with the obtained portions. Specifically, the DRM agent module 20 is installed to a canInitWithRequest method, a startLoading method, and a stopLoading method of a child class which is registered to a NSURLProtocol class of the APIs of the WebView SDK 11. A child class inherits the methods of the parent class which it has registered to. That is, the child class inherits the canInitWithRequest method, the startLoading method, and the stopLoading method of the NSURLProtocol class which is called for loading of resources required in the web page, and user defined behaviors may be added in the canInitWithRequest method, the startLoading method, and the stopLoading method for the installation of the DRM agent module 20.

The resource may be indicated by a HyperText Markup Language (HTML) or HTML5 src attribute of the web page. For example, an exemplary HTML/HTML5 code for requesting an image in a web page is given below:
<a><img src=‘file:///c:\MIB3_poster.png”/>click here</a>,
   , wherein <a> and <img> are HTML/HTML5 elements (or referred to as nodes), “src” is an attribute, the part encompassed by <a> and <a> is a hyperlink represented by a URL for indicating the location and file name of the requested image. Note that, the requested resources may comprise texts, java scripts, Cascade Style Sheets (CSS), audio/video, and canvas 2D, etc. The exemplary HTML/HTML5 code thereof is similar to the case of requesting an image described above, and thus, is omitted herein for brevity.

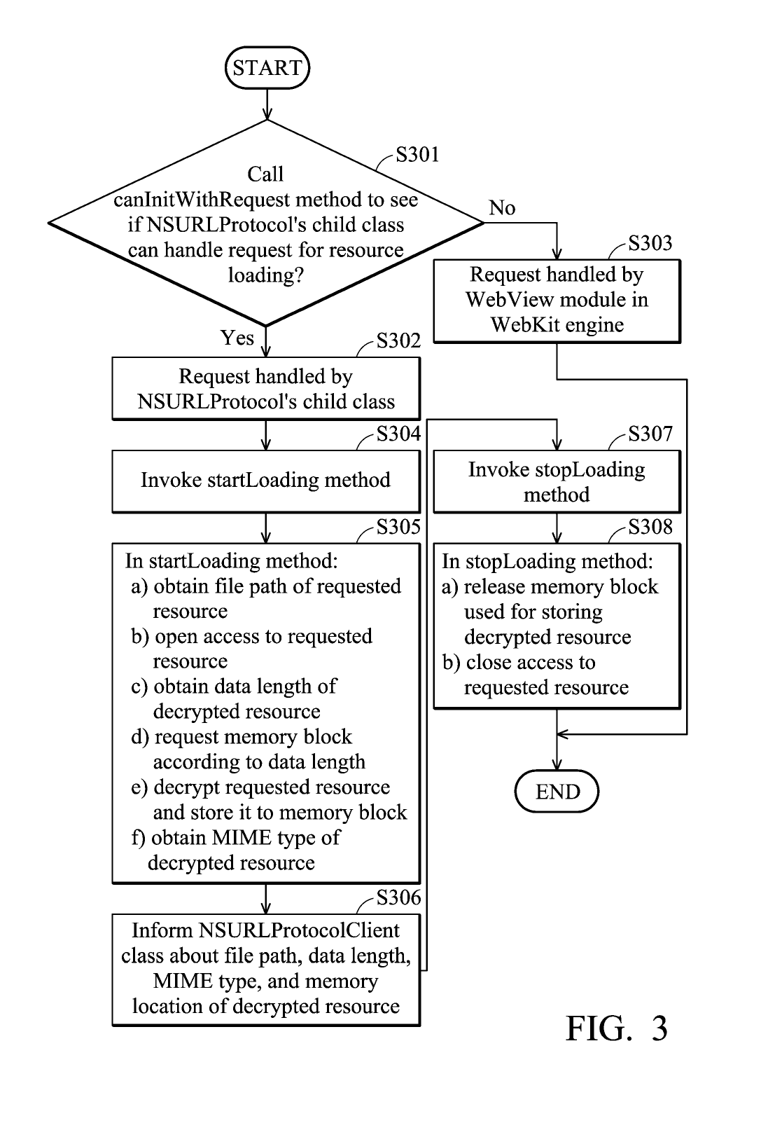

FIG. 3 is a flow chart illustrating the operations of the canInitWithRequest method, the startLoading method, and the stopLoading method installed with the DRM agent module 20 according to an embodiment of the invention. To begin, the WebResoureLoadDelegate delegate of the APIs of the WebView SDK 11 calls the canInitWithRequest method to determine whether the child class of the NSURLProtocol class is capable of handling the request for loading a resource required in the web page (step S301). Specifically, the canInitWithRequest method is called by the following method of the WebResoureLoadDelegate delegate:
webView: resource:willSendRequest:redirectResponse:fromDataSource:

The canInitWithRequest method is installed with the DRM agent module 20 (i.e., the canInitWithRequest method is overwritten and is different from a genuine canInitWithRequest method in the APIs of the WebView SDK for the Mac OS X or iOS system released to the public, and it may be referred to as a custom method made and used specifically in this invention), so as to determine whether the resource is DRM protected using one of the DRM schemes supported by the DRM agent module 20 according to a file extension or a header of the resource (i.e., use a specific kind of APIs of the DRM agents in the DRM agent module 20 one by one to check a specific field in the header until either an API of a DRM agent retrieves a correct value or all the DRM agents are exhausted and result negative response.) If a DRM agent, which is corresponding to a specific DRM scheme, succeeds in doing so, the canInitWithRequest method returns a TRUE value to the WebResoureLoadDelegate deledate, meaning that the request is to be handled by the child class of the NSURLProtocol class (step S302) and select the corresponding DRM agent of the determined DRM scheme for the following processing. Otherwise, if the resource is not DRM protected or protected by a DRM scheme not supported by the DRM agent module 20, the canInitWithRequest method returns a FALSE value to the WebResoureLoadDelegate deledate, meaning that the request is to be handled by the original information processing flow of the un-overwritten WebView module in the WebKit engine 12 (step S303).

Next, the startLoading method is invoked by the child class of the NSURLProtocol class (step S304). Specifically, the startLoading method is installed with the DRM agent module 20 (i.e., the startLoading method is overwritten and is different from a genuine startLoading method in the APIs of the WebView SDK for the Mac OS X or iOS system released to the public, and is may be referred to as a custom method made and used specifically in this invention), so as to receive the request for loading the resource, and activate the DRM agent module 20 for processing the DRM-protected content to obtain the resource portion-by-portion. Specifically, the DRM agent module 20 is activated to first obtain the file path of the requested resource, and then open access to the requested resource for DRM processing, including obtaining the data length of the decrypted resource, requesting for a memory block according to the data length, decrypting the requested resource and storing the decrypted resource in the memory block, and obtaining the Multipurpose Internet Mail Extensions (MIME) type of the decrypted resource (step S305).

The startLoading method informs the NSURLProtocolClient class about the file path, data length, MIME type, and memory location of the decrypted resource (step S306). After that, when the request for loading the resource has been completed, the stopLoading method is invoked by the child class of the NSURLProtocol class (step S307). Specifically, the stopLoading method is installed with the DRM agent module 20 (i.e., the stopLoading method is overwritten and is different from a genuine stopLoading method in the APIs of the WebView SDK for the Mac OS X or iOS system released to the public, and is may be referred to as a custom method made and used specifically in this invention), so as to release the memory block used for storing the decrypted resource and close the access to the requested resource (step S308).

In one embodiment, the installation of the DRM agent module 20 in the WebView SDK 11 may be performed by inserting the source code of the DRM agent module 20 in the canInitWithRequest method, the startLoading method, and the stopLoading method. In another embodiment, the installation of the DRM agent module 20 in the WebView SDK 11 may be performed by providing a code routine which was written using the API(s) of the DRM agent(s) in the DRM agent module 20 for calling the libraries of the DRM agent(s) in the DRM agent module 20 dynamically or statically, and inserting the code routine in the canInitWithRequest method, the startLoading method, and the stopLoading method.

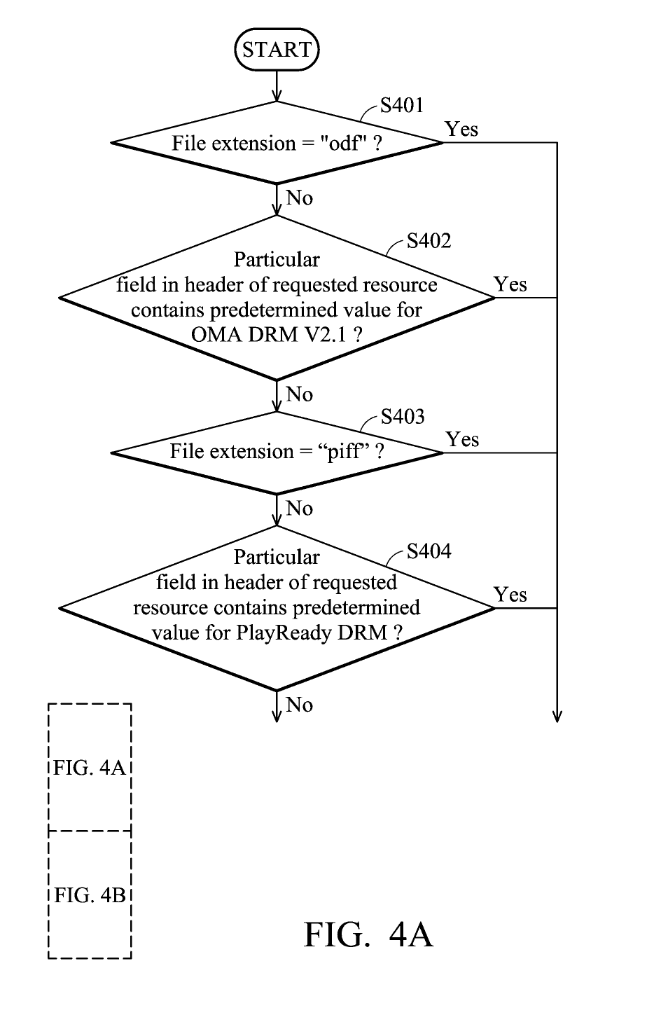

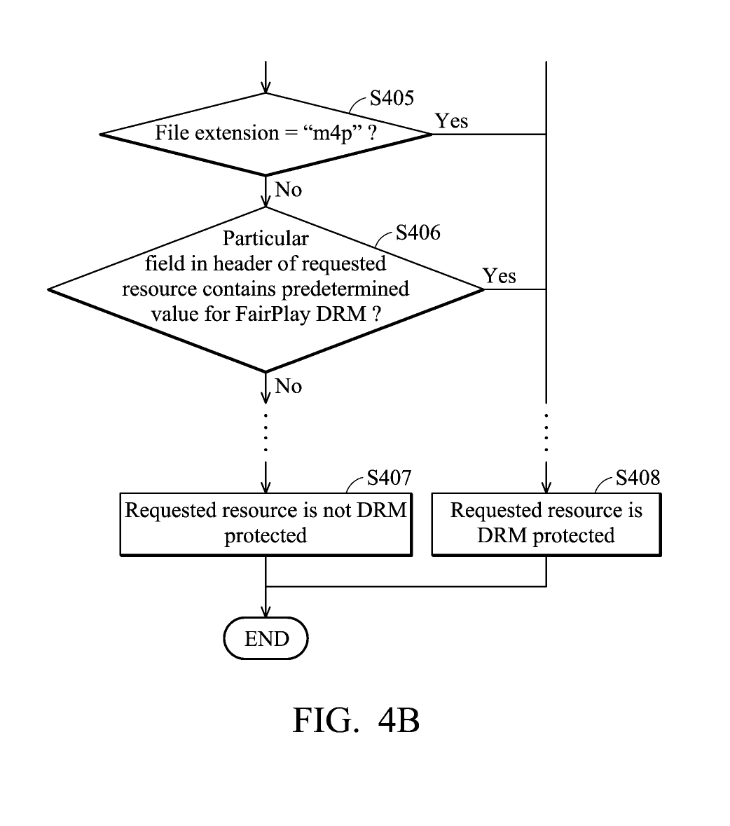

To further clarify, due to the fact that different DRM schemes, such as OMA DRM v2.1, PlayReady DRM, and FairPlay DRM, etc., may be employed, the determination of whether the resource is DRM protected may be performed once for each DRM scheme supported by the DRM agent module 20. FIGS. 4A and 4B show a flow chart illustrating the determination of whether the resource is DRM protected according to an embodiment of the invention. To begin, it is first checked if the requested resource is DRM protected in compliance with the OMA DRM v2.1, by determining whether the file extension is “odf” (step S401) and determining whether a particular field in the header of the requested resource contains a predetermined value for OMA DRM v2.1 (step S402). That is, the check is conducted by a specific API of the DRM agent corresponding to OMA DRM v2.1.

If both of the determination results in the steps S401 and S402 are negative, it is subsequently checked if the requested resource is DRM protected in compliance with the PlayReady DRM, by determining whether the file extension is “piff” (step S403) and determining whether a particular field in the header of the requested resource contains a predetermined value for PlayReady DRM (step S404). If both of the determination results in the steps S403 and S404 are negative, it is subsequently checked if the requested resource is DRM protected in compliance with the FairPlay DRM, by determining whether the file extension is “m4p” (step S405), and determining whether a particular field in the header of the requested resource contains a predetermined value for FairPlay DRM (step S406). The check continues until either a DRM agent retrieve a correct value or all the DRM agents in the DRM agent module 20 are exhausted and cannot retrieve a correct value. If the determination results in the steps S401 to S406 and following steps (if any) are negative, it means that the requested resource is not protected by any DRM scheme supported by the DRM agent module 20 (step S407). Otherwise, if one of the determination results in the steps S401 to S406 and subsequent steps (if any) is positive, it means that the requested resource is DRM protected (step S408). Note that, the steps S402, S404, and S406 are performed by activating the DRM agent module 20 to use its API(s) of specific DRM agent(s) corresponding to specific DRM scheme(s) for reading the particular field in the header of the requested resource.

Alternatively, for the checking of whether the requested resource is DRM protected in compliance with the OMA DRM v2.1, only one of the steps S401 and S402 may be performed instead of performing both the steps S401 and S402. Likewise, for the checking of whether the requested resource is DRM protected in compliance with the PlayReady DRM and FairPlay DRM, only one of the steps S403 and S404 may be performed instead of performing both the steps S403 and S404, and only one of the steps S405 and S406 may be performed instead of performing both the steps S405 and S406.

If the DRM-protected content is associated with a video/audio file, the WebKit engine 12 activates the processing of the DRM-protected content of the DRM agent to obtain the video/audio file portion-by-portion, and uses the native media player to play the video/audio file with the obtained portions. Taking the web browser for the Mac OS X or iOS system, the native media player is the QuickTime (QT) Kit, and the DRM agent module 20 is installed in the MediaPlayerPrivateQTKit class of the QT Kit, so that the processing of the DRM-protected content is activated when the web browser 10 is required to access the DRM-protected content associated with the video/audio file. Note that, the MediaPlayerPrivateQTKit class installed with the DRM agent module 20 is different from the genuine MediaPlayerPrivateQTKit class in the web browser for the Mac OS X or iOS system released to the public, and it may be referred to as a custom class made and used specifically in this invention. Specifically, the installation of the DRM agent module 20 in the WebKit engine 12 may be performed by inserting, in the MediaPlayerPrivateQTKit mm file, the source code of the DRM agent module 20 or a code routine which was written using the API(s) of the DRM agent(s) in the DRM agent module 20 for calling the libraries of the DRM agent(s) in the DRM agent module 20 dynamically or statically. It is noted that, though the video and audio files can be handled by the native player, they can also be alternatively handled by plug-ins, such as VLC plug-in or Windows Media Player plug-in, as other electronic files.

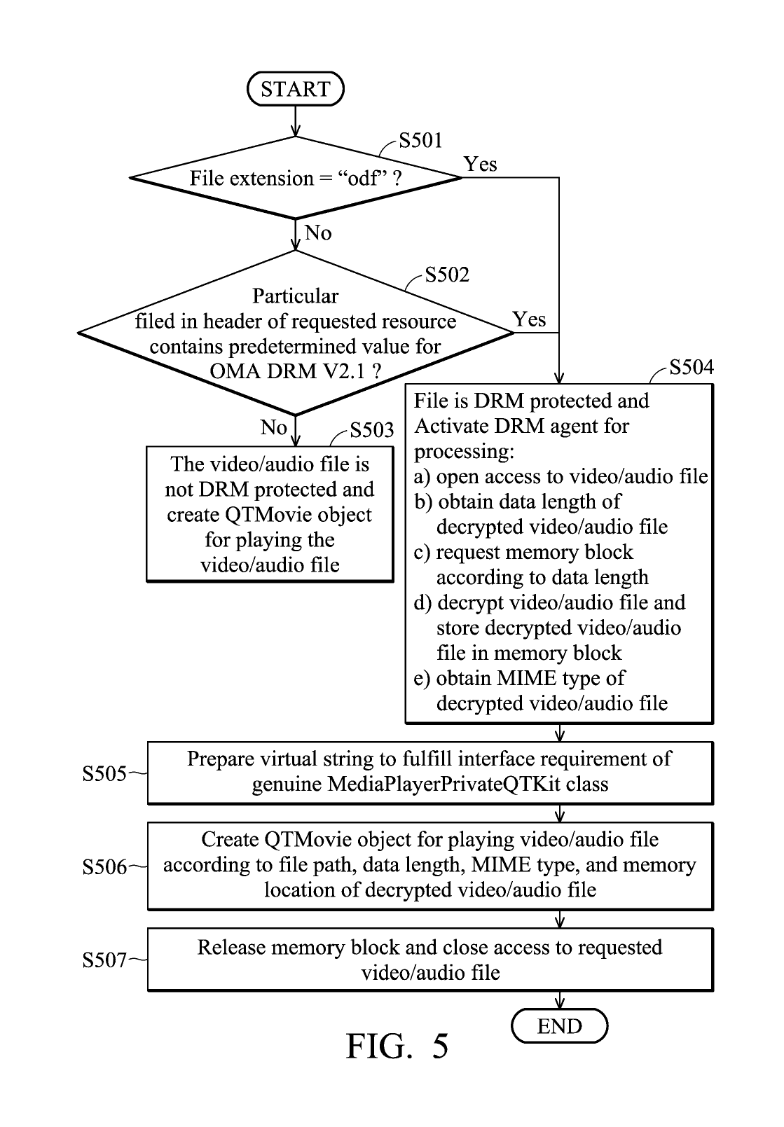

FIG. 5 is a flow chart illustrating the operation of the customized MediaPlayerPrivateQTKit class according to an embodiment of the invention. In this embodiment, for simplifying illustration, it is assumed that the DRM agent module 20 only supports OMA DRM v2.1, but the invention is not limited thereto. To begin, the customized MediaPlayerPrivateQTKit class first checks if the video/audio file is DRM protected using OMA DRM v2.1, by determining whether the file extension is “odf” (step S501) and determining whether a particular field in the header of the requested resource contains a predetermined value for OMA DRM v2.1 (step S502). Specifically, the step S502 is performed by activating the DRM agent module 20 to use its API(s) for reading the particular field in the header of the requested resource. If both of the determination results in the steps S501 and S502 are negative, the customized MediaPlayerPrivateQTKit class creates a default QTMovie object for playing the video/audio file (step S503). Otherwise, if one of the determination results in the steps S501 and S502 is positive, the customized MediaPlayerPrivateQTKit class activates the DRM agent module 20 to first obtain the file path of the video/audio file, the data length of the decrypted video/audio file and the Multipurpose Internet Mail Extensions (MIME) type of the video/audio file, and then open the video/audio file for DRM processing, including decrypting the video/audio file, requesting for a memory block according to the data length according to the data length information retrieved, decrypting the video/audio file and storing the decrypted video/audio file in the memory block (step S504).

Alternatively, in another embodiment, the steps S501 and S502 may be performed for a different DRM scheme, such as PlayReady DRM, or FairPlay DRM, etc., or may be performed more than once for each of a plurality of different DRM schemes supported by the DRM agent module 20 until all of the DRM schemes supported by the DRM agent module 20 have been tried out or until one of the checks returns a TRUE value.

Subsequently, the customized MediaPlayerPrivateQTKit class prepares a virtual string to fulfill the interface requirement of the genuine MediaPlayerPrivateQTKit class (step S505), and then creates a QTMovie object for playing the video/audio file according to the file path, data length, MIME type, and memory location of the decrypted video/audio file (step S506). After that, when finishing the playing of the video/audio file, the customized MediaPlayerPrivateQTKit class releases the memory block used for storing the decrypted video/audio file, and then closes the access to the requested video/audio file (step S507). Note that, the virtual string is merely prepared as dummy data to fit in the interface requirement of the genuine QTMovie class, and it is not used for playing the video/audio file in the customized QTMovie object.

If the DRM-protected content is associated with an electronic file which requires a specific plug-in to access, the WebKit engine 12 activates the processing of the DRM-protected content of the DRM agent module 20 to obtain the electronic file portion-by-portion, and uses the corresponding plug-in, e.g., the plug-in 30, to access the electronic file with the obtained portions. Specifically, the DRM agent module 20 is installed to one or more of a plurality of methods in the WebKit engine 12, which are invoked during the loading of the DRM-protected content associated with the electronic file, so that the processing of the DRM-protected content by the DRM agent module 20 is activated when the web browser 10 is required to access the DRM-protected content associated with the electronic file. After that, when finishing the loading of the DRM-protected content associated with the electronic file, the WebKit engine 12 may use the corresponding plug-in, e.g., the plug-in 30, to access the electronic file. Similar to the steps S401 to S406 in FIGS. 4A and 4B, the DRM-protected content associated with the electronic file may be checked first to see if it is DRM protected and by which DRM scheme it is protected with or without activating the DRM agent module 20, and if it is protected by a DRM scheme which is supported by the DRM agent module 20, then the DRM agent appropriate for the DRM scheme in the DRM agent module 20 is activated for processing the DRM-protected content associated with the electronic file.

Alternatively, in addition to the access of electronic files, including program files and multimedia/data files, the WebKit engine 12 installed with the DRM agent module 20 may handle the displaying of web pages and other types of electronic files as well, since the WebView SDK 11 is generally built from the WebKit engine 12. This is particularly suitable for the case where the web browser 10 is for the operating systems in which the WebView SDK 11 is provided with different architecture or the WebView SDK 11 is not provided at all.

Similar to the installation of the DRM agent module 20 in the WebView SDK 11 as described above, the installation of the DRM agent module 20 in the WebKit engine 12 may be performed by inserting the source code of the DRM agent module 20 in the set of methods in the WebKit engine 12, or by providing a code routine which was written using the API of the DRM agent(s) in the DRM agent module 20 for calling the libraries of the DRM agent(s) in the DRM agent module 20 dynamically or statically and inserting the code routine in the set of methods in the WebKit engine 12.

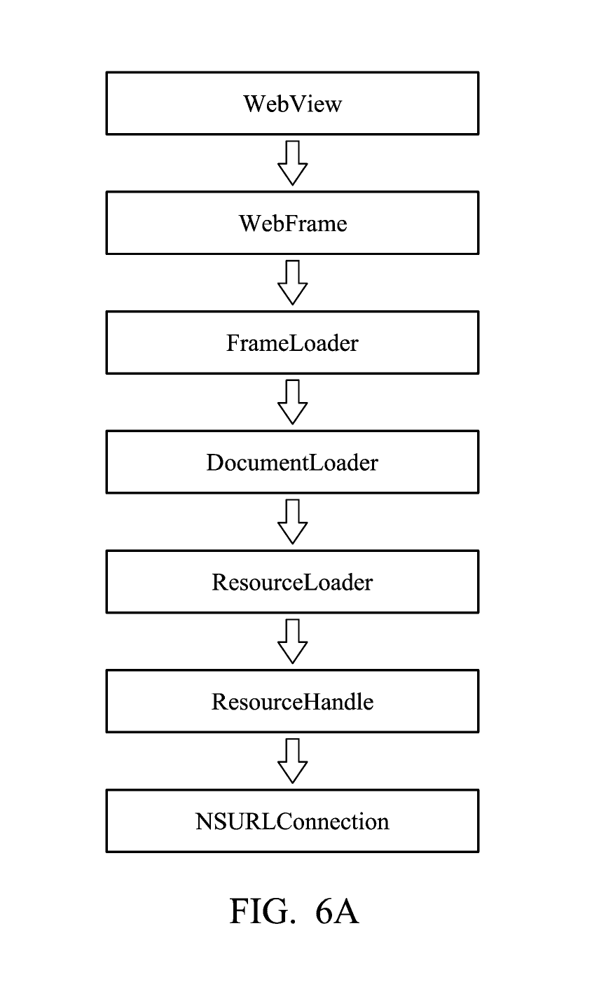

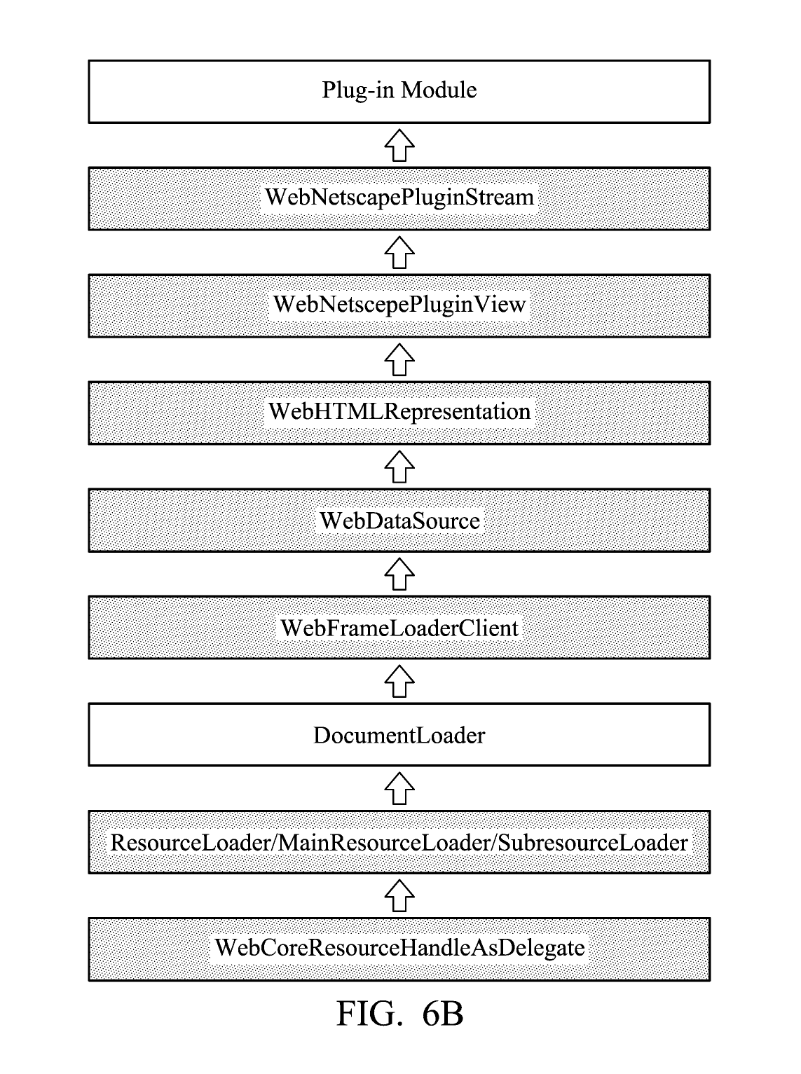

Taking the web browser for the Mac OS X or iOS system as an example, the calling sequence of the classes in the WebKit engine 12 involved during the loading of the DRM-protected content associated with the electronic file is illustrated in FIG. 6A, and the returning sequence of the classes in the WebKit engine 12 involved during the loading of the DRM-protected content associated with the electronic file is illustrated in FIG. 6B. Particularly, as shown in FIG. 6B, the blocks with the patterned background represent the classes where the set of methods installed with the DRM agent module 20 are selected from.

In a first embodiment, the installation of the DRM agent module 20 in the WebKit engine 12 may be implemented in the didReceiveResponse, didReceiveData method, and didFinishLoading method of the WebCoreResourceHandleAsDelegate class. The didReceiveResponse method is overwritten to activate the DRM agent module 20 for obtaining the MIME type and data size of the electronic file, and to replace the MIME type and the data size contained in a NSURLResponse object with the obtained MIME type and data size of the electronic file. The didReceiveData method is overwritten to request for a memory block, activate the DRM agent module 20 for processing the DRM-protected content to obtain the electronic file and store it in the memory block, and replace the data content and length contained in an NSData object with the content and length of the electronic file. The NSURLResponse object and the NSData object are passed down to the next class in the returning sequence. The didFinishLoading method is overwritten to activate the DRM agent module 20 for closing the access to the electronic file, when finishing the loading of the DRM-protected content in this class.

In a second embodiment, the installation of the DRM agent module 20 in the WebKit engine 12 may be implemented in the didReceiveResponse, didReceiveData method, and didFinishLoading method of the ResourceLoader class (or MainResourceLoader or SubresourceLoader of similar classes). The didReceiveResponse method is overwritten to activate the DRM agent module 20 for obtaining the MIME type and data size of the electronic file, and to replace the MIME type and the data size contained in a ResourceResponse object with the obtained MIME type and data size of the electronic file. The didReceiveData method is overwritten to request for a memory block, activate the DRM agent module 20 for processing the DRM-protected content to obtain the electronic file and store it in the memory block. The ResourceResponse object, and the content and location of the electronic file are passed down to the next class in the returning sequence. The didFinishLoading method is overwritten to activate the DRM agent module 20 for closing the access to the electronic file, when finishing the loading of the DRM-protected content in this class.

In a third embodiment, the installation of the DRM agent module 20 in the WebKit engine 12 may be implemented in the committedLoad method and finishedLoading method of the WebFrameLoaderClient class. The committedLoad method is overwritten to activate the DRM agent module 20 for obtaining the MIME type and data size of the electronic file, and to replace the MIME type and the data size contained in a NSURLResponse object referenced by a DocumentLoader object with the obtained MIME type and data size of the electronic file. Also, the committedLoad method is overwritten to activate the DRM agent module 20 for processing the DRM-protected content to obtain the electronic file and store it in a memory block. The DocumentLoader object, and the content and location of the electronic file are passed down to the next class in the returning sequence. The finishLoading method is overwritten to activate the DRM agent module 20 for closing the access to the electronic file, when finishing the loading of the DRM-protected content in this class.

In a fourth embodiment, the installation of the DRM agent module 20 in the WebKit engine 12 may be implemented in the _receivedData method and _finishedLoading method of the WebDataSource class. The _receivedData method is overwritten to activate the DRM agent module 20 for obtaining the MIME type and data size of the electronic file, and to replace the MIME type and the data size contained in a NSURLResponse object referenced by a DocumentLoader object with the obtained MIME type and data size of the electronic file. Also, the _receivedData method is overwritten to activate the DRM agent module 20 for processing the DRM-protected content to obtain the electronic file and store it in a memory block. The DocumentLoader object, and the content and location of the electronic file are passed down to the next class in the returning sequence. The _finishedLoading method is overwritten to activate the DRM agent module 20 for closing the access to the electronic file, when finishing the loading of the DRM-protected content in this class.

In a fifth embodiment, the installation of the DRM agent module 20 in the WebKit engine 12 may be implemented in the receivedData method and finishedLoadingWithDataSource method of the WebHTMLRepresentation class. The receivedData method is overwritten to activate the DRM agent module 20 for obtaining the MIME type and data size of the electronic file, and to replace the MIME type and the data size contained in a NSURLResponse object referenced by a WebDataSource object with the obtained MIME type and data size of the electronic file. Also, the receiveData method is overwritten to activate the DRM agent module 20 for processing the DRM-protected content to obtain the electronic file and store it in a memory block. The WebDataSource object, and the content and location of the electronic file are passed down to the next class in the returning sequence. The finishedLoadingWithDataSource method is overwritten to activate the DRM agent module 20 for closing the electronic file, when finishing the loading of the DRM-protected content in this class.

In a sixth embodiment, the installation of the DRM agent module 20 in the WebKit engine 12 may be implemented in the receivedResponse method, receivedData method, and pluginViewFinishedLoading method of the WebNetscapePluginView class. The receivedResponse method is just to create a WebNetscapePluginStream object. The receivedData method is overwritten to call the startStreamWithResponse method in the WebNetscapePluginStream object for receiving a WebDataSource object with a referenced ResourceResponse object. After that, the overwritten receivedData method activates the DRM agent module 20 for obtaining the MIME type and data size of the electronic file, and to replace the MIME type and data size contained in the ResourceResponse object with the obtained MIME type and data size of the electronic file. Also, the overwritten receivedData method activates the DRM agent module 20 for processing the DRM-protected content to obtain the electronic file and store it in a memory block. The ResourceResponse object, and the content and location of the electronic file are passed down to the next class in the returning sequence. The pluginViewFinishedLoading method is overwritten to activate the DRM agent module 20 for closing the electronic file, when finishing the loading of the DRM-protected content in this class.

In a seventh embodiment, the installation of the DRM agent module 20 in the WebKit engine 12 may be implemented in the startStreamWithResponse method, didReceiveData method, and didFinishLoading method of the WebNetscapePluginStream class. The startStreamWithResponse method is overwritten to activate the DRM agent module 20 for obtaining the MIME type and data size of the electronic file, and to replace the MIME type and data size contained in a ResourceResponse object with the obtained MIME type and data size of the electronic file. The didReceiveData method is overwritten to activate the DRM agent module 20 for processing the DRM-protected content to obtain the electronic file and store it in a memory block. The ResourceResponse object, and the content and location of the electronic file are passed down to the next class in the returning sequence. The didFinishLoading method is overwritten to activate the DRM agent module 20 for closing the electronic file, when finishing the loading of the DRM-protected content in this class.

Note that, in addition to the methods and classes mentioned in the seven embodiments described above, other methods and classes in the WebKit engine 12 bearing similar functions (e.g., delivering information during the loading of the DRM-protected content) or structures of the aforementioned ones, or the methods and classes with different name but similar functions or structures of the aforementioned ones, or the updated versions of the aforementioned methods and classes, or methods and classes being re-casted in different unit but still performing similar functions, may be selected for installing the DRM agent module 20. Alternatively, the installation of the DRM agent module 20 in the WebKit engine 12 is not limited to only the methods from the same class. That is, the DRM agent module 20 may be installed to any combination of the methods mentioned in the seven embodiments, as long as the combination of methods covers the obtaining of necessary information, such as the MIME type, data length, and decrypted content, for processing of the DRM-protected content. For example, the installation of the DRM agent module 20 in the WebKit engine 12 may be implemented in the didReceiveResponse method of the WebCoreResourceHandleAsDelegate class, the didReceiveData method of the ResourceLoader class, and the didFinishLoading method of the WebNetscapePluginStream class.

It is to be understood that, although the web browsers for the Mac OS X or iOS system are used as preferred exemplary web browsers in the description of the aforementioned embodiments, other web browsers constructed by WebView SDK and/or WebKit engine bearing similar functions of the aforementioned ones, etc., or any web browser for the operating systems other than the Mac OS X and iOS system, e.g., the Windows XP/7/8 systems, in which the WebView SDK is provided with different architecture or the WebView SDK is not provided at all, may be used instead, and the invention is not limited thereto.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the invention shall be defined and protected by the following claims and their equivalents.

What is claimed is:

1. An electronic device for digital content protection using Digital Rights Management (DRM), comprising:
a DRM agent, processing DRM-protected content associated with an electronic file or a web page;
a plug-in, enabling access of the electronic file; and
a web browser, comprising a WebView Software Development Kit (SDK) installed with the DRM agent or a WebKit engine installed with the DRM agent,
wherein the WebView SDK activates the processing of the DRM-protected content of the DRM agent to obtain the web page portion-by-portion, and displays the web page with the obtained portions, and
wherein the WebKit engine activates the processing of the DRM-protected content of the DRM agent to obtain the electronic file or the web page portion-by-portion, and uses the plug-in or a native media player of the WebKit engine to access the electronic file with the obtained portions, or displays the web page with the obtained portions.

2. The electronic device of claim 1, wherein, prior to activating the processing of the DRM-protected content of the DRM agent, the WebView SDK or the WebKit engine determines whether the DRM-protected content is DRM protected using one of a plurality of DRM schemes according to a file extension of the DRM-protected content, and the processing of the DRM-protected content is activated in response to determining that the DRM-protected content is DRM protected using one of the DRM schemes.

3. The electronic device of claim 1, wherein the processing of the DRM-protected content of the DRM agent is also activated to determine whether the DRM-protected content is DRM protected using one of a plurality of DRM schemes according to a header of the DRM-protected content, and the obtaining of the electronic file or the web page portion-by-portion is performed in response to determining that the DRM-protected content is DRM protected using one of the DRM schemes.

4. The electronic device of claim 1, wherein the WebView SDK provides a set of Application Programming Interfaces (APIs), and the DRM agent is installed to a canInitWithRequest method, a startLoading method and a stopLoading method of a child class which is registered to a NSURLProtocol class of the APIs, when the electronic device is operating a Mac OS X or iOS system, so that the processing of the DRM-protected content is activated when the web browser is required to access the DRM-protected content associated with the web page.

5. The electronic device of claim 1, wherein the native media player of the WebKit engine is a QuickTime (QT) Kit when the electronic device is operating a Mac OS X or iOS system, and the DRM agent is installed in a MediaPlayerPrivateQTKit class of the QT Kit, so that the processing of the DRM-protected content is activated when the web browser is required to access the DRM-protected content associated with the electronic file.

6. The electronic device of claim 1, wherein the DRM agent is installed to one or more of a plurality of methods in the WebKit engine, which are invoked during loading of the DRM-protected content associated with the electronic file, so that the processing of the DRM-protected content is activated when the web browser is required to access the DRM-protected content associated with the electronic file.

7. The electronic device of claim 6, wherein, when the electronic device is operating a Mac OS X or iOS system, the methods comprise:
a didReceiveResponse method, a didReceiveData method, and a didFinishLoading method of a WebCoreResourceHandleAsDelegate, ResourceLoader, MainResourceLoader, or SubresourceLoader class;
a committedLoad method and a finishedLoading method of a WebFrameLoaderClient class;
a _receivedData method and a _finishedLoading method of a WebDataSource class;
a receivedData method and a finishedLoadingWithDataSource method of a WebHTMLRepresentation class;
a receivedResponse method, a receivedData, and a pluginViewFinishedLoading method of a WebNetscapePluginView class; and
a startStreamWithResponse method, a didReceiveData, and a didFinishLoading method of a WebNetscapePluginStream class.

8. A method for digital content protection using Digital Rights Management (DRM) in an electronic device, comprising:
launching a web browser comprising a WebView Software Development Kit (SDK) installed with a DRM agent or a WebKit engine installed with the DRM agent, wherein the DRM agent is configured for processing DRM-protected content associated with an electronic file or a web page;
activating, by the WebView SDK, the DRM agent to process the DRM-protected content for obtaining the web page portion-by-portion, and displaying, by the WebView SDK, the web page with the obtained portions, in response to the web browser comprising the WebView SDK installed with the DRM agent; and
activating, by the WebKit engine, the DRM agent to process the DRM-protected content for obtaining the electronic file or the web page portion-by-portion, and using, by the WebKit engine, a plug-in or a native media player of the WebKit engine to access the electronic file with the obtained portions, or displaying, by the WebKit engine, the web page with the obtained portions, in response to the web browser comprising the WebKit engine installed with the DRM agent.

9. The method of claim 8, further comprising, prior to activating the processing of the DRM-protected content of the DRM agent, determining, by the WebView SDK or the WebKit engine, whether the DRM-protected content is DRM protected using one of a plurality of DRM schemes according to a file extension of the DRM-protected content, wherein the processing of the DRM-protected content is activated in response to determining that the DRM-protected content is DRM protected using one of the DRM schemes.

10. The method of claim 8, wherein the DRM agent is also activated to determine whether the DRM-protected content is DRM protected using one of a plurality of DRM schemes according to a header of the DRM-protected content, and the obtaining of the electronic file or the web page portion-by-portion is performed in response to determining that the DRM-protected content is DRM protected using one of the DRM schemes.

11. The method of claim 8, wherein the WebView SDK provides a set of Application Programming Interfaces (APIs), and the DRM agent is installed to a canInitWithRequest method, a startLoading method and a stopLoading method of a child class which is registered to a NSURLProtocol class of the APIs, when the electronic device is operating a Mac OS X or iOS system, so that the processing of the DRM-protected content is activated when the web browser is required to access the DRM-protected content associated with the web page.

12. The method of claim 8, wherein the native media player of the WebKit engine is a QuickTime (QT) Kit when the electronic device is operating a Mac OS X or iOS system, and the DRM agent is installed in a MediaPlayerPrivateQTKit class of the QT Kit, so that the processing of the DRM-protected content is activated when the web browser is required to access the DRM-protected content associated with the electronic file.

13. The method of claim 8, wherein the DRM agent is installed to one or more of a plurality of methods in the WebKit engine, which are invoked during loading of the DRM-protected content associated with the electronic file, so that the processing of the DRM-protected content is activated when the web browser is required to access the DRM-protected content associated with the electronic file.

14. The method of claim 13, wherein, when the electronic device is operating a Mac OS X or iOS system, the methods comprise:
a didReceiveResponse method, a didReceiveData method, and a didFinishLoading method of a WebCoreResourceHandleAsDelegate, ResourceLoader, MainResourceLoader, or SubresourceLoader class;
a committedLoad method and a finishedLoading method of a WebFrameLoaderClient class;
a _receivedData method and a _finishedLoading method of a WebDataSource class;
a receivedData method and a finishedLoadingWithDataSource method of a WebHTMLRepresentation class;
a receivedResponse method, a receivedData, and a pluginViewFinishedLoading method of a WebNetscapePluginView class; and
a startStreamWithResponse method, a didReceiveData, and a didFinishLoading method of a WebNetscapePluginStream class.

15. An electronic device for digital content protection using Digital Rights Management (DRM), comprising:
a plurality of DRM agents, supporting a plurality of DRM schemes for processing DRM-protected content associated with an electronic file or a web page using one of the DRM schemes;
a plug-in, enabling access of the electronic file; and
a web browser, comprising a WebView Software Development Kit (SDK) installed with the DRM agents or a WebKit engine installed with the DRM agents,
wherein the WebView SDK activates the processing of the DRM-protected content of the DRM agents to obtain the web page portion-by-portion, and displays the web page with the obtained portions, and
wherein the WebKit engine activates the processing of the DRM-protected content of the DRM agents to obtain the electronic file or the web page portion-by-portion, and uses the plug-in or a native media player of the WebKit engine to access the electronic file with the obtained portions, or displays the web page with the obtained portions.

16. The electronic device of claim 15, wherein, prior to activating the processing of the DRM-protected content of the DRM agents, the WebView SDK or the WebKit engine determines whether the DRM-protected content is DRM protected using one of a plurality of DRM schemes according to a file extension of the DRM-protected content, and the processing of the DRM-protected content is activated in response to determining that the DRM-protected content is DRM protected using one of the DRM schemes.

17. The electronic device of claim 15, wherein the processing of the DRM-protected content of the DRM agents is also activated to determine whether the DRM-protected content is DRM protected using one of a plurality of DRM schemes according to a header of the DRM-protected content, and the obtaining of the electronic file or the web page portion-by-portion is performed in response to determining that the DRM-protected content is DRM protected using one of the DRM schemes.

18. The electronic device of claim 15, wherein the WebView SDK provides a set of Application Programming Interfaces (APIs), and the DRM agents are installed to a canInitWithRequest method, a startLoading method and a stopLoading method of a child class which is registered to a NSURLProtocol class of the APIs, when the electronic device is operating a Mac OS X or iOS system, so that the processing of the DRM-protected content is activated when the web browser is required to access the DRM-protected content associated with the web page.

19. The electronic device of claim 15, wherein the native media player of the WebKit engine is a QuickTime (QT) Kit when the electronic device is operating a Mac OS X or iOS system, and the DRM agents are installed in a MediaPlayerPrivateQTKit class of the QT Kit, so that the processing of the DRM-protected content is activated when the web browser is required to access the DRM-protected content associated with the electronic file.

20. The electronic device of claim 15, wherein the DRM agents are installed to one or more of a plurality of methods in the WebKit engine, which are invoked during loading of the DRM-protected content associated with the electronic file, so that the processing of the DRM-protected content is activated when the web browser is required to access the DRM-protected content associated with the electronic file.

21. The electronic device of claim 20, wherein, when the electronic device is operating a Mac OS X or iOS system, the methods comprise:
a didReceiveResponse method, a didReceiveData method, and a didFinishLoading method of a WebCoreResourceHandleAsDelegate, ResourceLoader, MainResourceLoader, or SubresourceLoader class;
a committedLoad method and a finishedLoading method of a WebFrameLoaderClient class;
a _receivedData method and a _finishedLoading method of a WebDataSource class;
a receivedData method and a finishedLoadingWithDataSource method of a WebHTMLRepresentation class;
a receivedResponse method, a receivedData, and a pluginViewFinishedLoading method of a WebNetscapePluginView class; and
a startStreamWithResponse method, a didReceiveData, and a didFinishLoading method of a WebNetscapePluginStream class.
